(19) United States
(12) Patent Application Publication
(10) Pub. No.: US 2017/0310126 A1
(43) Pub. Date: Oct. 26, 2017

(54) VOLTAGE REGULATION FOR BATTERY STRINGS

(71) Applicant: HEWLETT PACKARD ENTERPRISE DEVELOPMENT LP, Houston, TX (US)

(72) Inventor: Hai Ngoc Nguyen, Spring, TX (US)

(21) Appl. No.: 15/039,414

(22) PCT Filed: Jan. 27, 2014
(86) PCT No.: PCT/US2014/013197

§ 371 Date: May 25, 2016

(51) Int. Cl. H02J 7/00

(52) U.S. Cl. CPC H02J 7/0018; H02J 7/0021

(57) ABSTRACT

A system for regulating voltage and current capability for a battery is described herein. The system includes at least two parallel battery strings to power a system load, where each battery string acts independently of another battery string. The system also includes a current sensor to determine an individual discharging current through each battery string in a circuit. The system also includes a switch to power on a particular battery string to support the system load by discharging current.

### BACKGROUND

Batteries are output voltage components that may act as an uninterruptible power supply (UPS) in the event of a power outage or surge by providing uninterrupted power. When batteries are discharged due to usage, its output voltage may fall to a certain voltage level below its charged voltage. The difference in the charged voltage and the output voltage, in a given application, may be considered as voltage regulation points of the battery. For example, a lithium ion battery when fully charged may have a charged voltage of 4.2V and a discharge voltage of 2.5V. This is a 40% swing in the battery output voltage. Thus, with most batteries, the voltage range discharged from the batteries may be relatively wide as compared to a voltage regulation tolerance as required by a device that the batteries may be servicing. The voltage regulation tolerance may be defined as the accuracy of the output voltage of the device.

In order to properly service a device, the voltage regulation tolerance of batteries may be tightened before supplying power to the device. To meet the requirement, a direct current to direct current (dc-dc) converter may be utilized to bring the wide voltage range of the batteries into the tighter voltage regulation tolerance range as required by the device.

### BRIEF DESCRIPTION OF THE DRAWINGS

Certain examples are described in the following detailed description and in reference to the drawings, in which:

FIG. 1 is an illustration of an example of a voltage regulation system including parallel battery strings, a charger, and switches without the use of a dc-dc converter;

FIG. 2 is an illustration of another example of a voltage regulation system including parallel battery strings, a battery monitoring system (BMS), switches, and a microcontroller (MCU) without the use of a dc-dc converter;

FIG. 3 is a graph of battery voltage and current curves for one (1) battery string;

FIG. 4 is a graph of battery voltage and current curves for two (2) battery strings;

FIG. 5 is a graph of battery voltage and current curves for three (3) battery strings;

FIGS. 6A-6D provide an illustration of discharging procedures for a battery string;

FIG. 7 is a block diagram of a discharging procedure for a battery string;

FIG. 8 is an illustration of a charging procedure for each individual battery string;

FIG. 9 is a block diagram of a charging procedure for a battery string; and

FIG. 10 is a block diagram of a tangible, non-transitory computer-readable medium configured to regulate voltage and current capability for a battery.

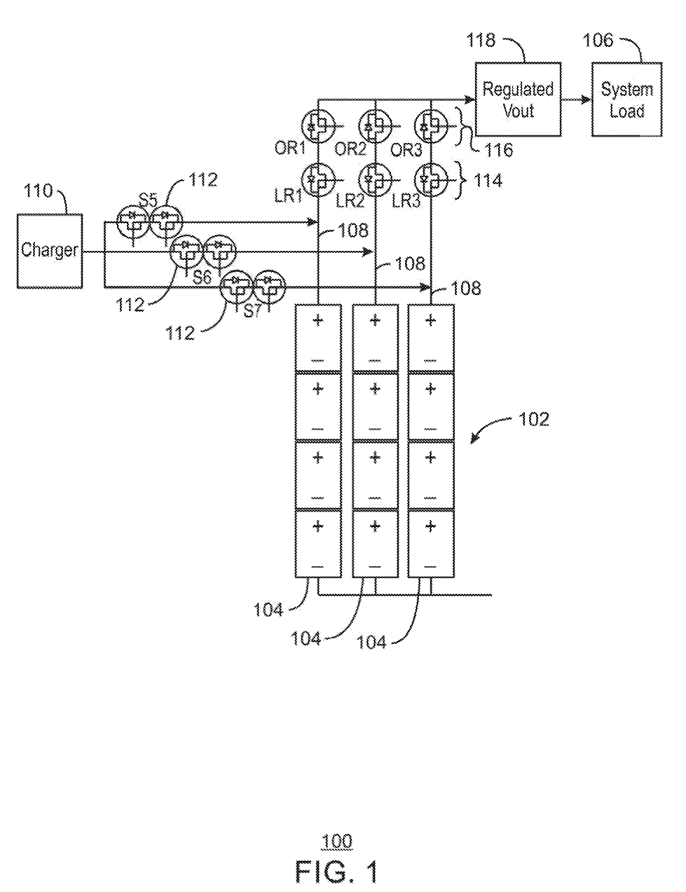

The same numbers may be used throughout the disclosure and the figures to reference like components and features. Numbers in the 100 series refer to features originally found in FIG. 1; numbers in the 200 series refer to features originally found in FIG. 1; and so on.

### DETAILED DESCRIPTION

Energy management systems such as a battery backup system may prove capable in energy-limited situations. For example, a typical system load may include 12-volt (V) input converters that may require a discharged voltage from a battery to be within +/−10% of the 12V input, e.g., a range of 10.8V to 13.2V. To meet this tight voltage regulation range, a dc-dc converter may be implemented to regulate the discharged voltage range from the battery and to deliver the discharge voltage of the battery within the range required by the input converters. The system load may include servers, drivers, memory cards, solid-state memory devices, processors, among others.

However, the use of a dc-dc converter may have several disadvantages including the requirement of additional space for installation, excessive cost, and excessive heat loss. Additionally, the electrical connection between the input and output of the dc-dc converter offers little to no protection to a load for high electrical voltage, high electrical current, or both.

Examples described herein provide a selective voltage regulation for parallel battery strings. In an example, a series of switches may replace a dc-dc converter to supply power via a power supply, such as a battery cell, to a system load. A typical 12V system load may require the discharge voltage from the battery cell to be within a tight voltage regulation range such as +/−10 of 12V, e.g., 10.8V-13.2V. However, the battery cell may provide a wider discharge voltage range (e.g., 10V-16.8V). Accordingly, a series of switches associated with each individual battery string may be utilized to tighten and narrow the wide voltage range of the battery cell to within the limits of the voltage regulation range as required by the system load.

FIG. 1 is an illustration of an example of a voltage regulation system 100 including parallel battery strings, a charger, and switches without the use of a dc-dc converter. FIG. 1 depicts a battery cell 102 including three batteries strings 104 in parallel connection, where each string 104 contains four batteries in series. In one or more examples, at least two parallel strings of batteries 104 may be utilized to power the system load 106. Each individual battery string 104 may act independently of another battery string 104 in providing a discharge voltage 108 to the system load 106. Additionally, each battery string 104 may be charged individually and sequentially using a charger 110 associated with a series of switches 112.

The discharge voltage 108 from the string of batteries 104 may include a voltage range that is outside of the range required for the input converters of the system load 106. For example, each battery string 104 may discharge a voltage of 2.5V in series and a voltage of 4.2V in parallel to provide a total voltage of 10V and 16.8V, respectively. However, the system load 106 may only support a voltage range of 10.8V to 13.2V. Due to the detrimental effects that excessive voltage range from the string of batteries 104 may cause, the discharge voltage 108 from the string of batteries 104 may be regulated to within +/−10% of a requirement of the system load, for example a 12V requirement of the system load 106.

As previously mentioned, a conventional 12V converter of the system load 106 may include a dc-dc converter to regulate the discharge voltage 108 from the battery cell 102 to within a range that may be acceptable. However, as shown in FIG. 1, the dc-dc converter may be replaced with a series of switches 114 and 116, including a series of linear regulators (LR1-LR3) 114 and OR-ings (OR1-OR3) 116, which may be utilized to convert the discharge voltage 108 from the battery cell 102 into an acceptable input for the system load 106. Each individual switch in the series of switches 114 and 116 may be opened (i.e., in an OFF position) or closed (i.e., in an ON position) based on the needs of the system load 106. Therefore, the amount of regulated discharged voltage 118 from the string of batteries 104 into the system load 106 may be regulated by the opening or closing of the switches 114 and 116.

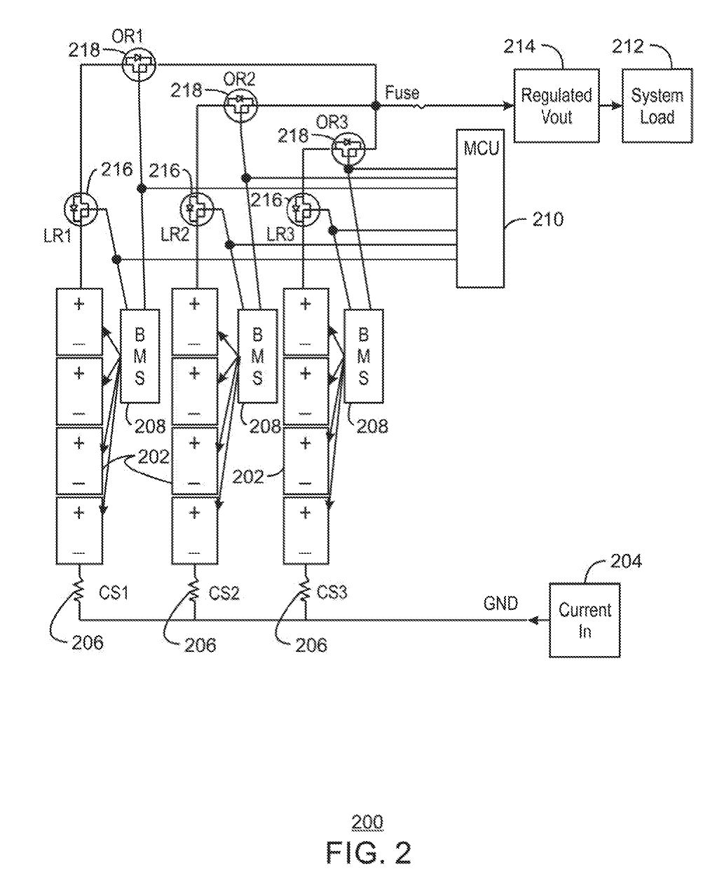

FIG. 2 is an illustration of another example of a voltage regulation system 200 including parallel battery strings, a battery monitoring system (BMS), switches, and a microcontroller (MCU) without the use of a dc-dc converter. As shown in FIG. 2, the system 200 may include three battery strings 202 in parallel connection, where each string 202 contains four batteries in series and where each string 202 may be operated independently of one another. For example, each battery string 202 may be charged individually and sequentially using a charger (not shown). In one or more examples, at least two battery strings may be utilized as the power source.

Current 204 may enter the voltage regulation system 200 from a ground plane, where several current sensors (CS1-CS3) 206 may be implemented to detect the flow of current through each battery string 202 and to generate a signal proportional to the current 204. Additionally, voltage probes (not shown) may be attached to the CS1-CS3 206 to detect the amount of voltage flowing through each battery string 202. The information from the CS1-CS3 206 may be used by a battery monitoring system 208 (BMS) in order to determine the individual current flowing through each battery string 202. The BMS 208 may also monitor the status of each of the battery strings 202 by monitoring the charge current, the discharge current, the state of charge, the health of each string, among other parameters.

The status of the battery string 202 generated by the BMS 208 may be reported to a microcontroller unit (MCU) 210, which may work in conjunction with a system load 212. Upon receiving the status of each battery string 202, the MCU 210 may communicate such information to several servers (not shown) of the system load 212. The MCU 210 may then either receive a signal from the server of the system load 212 indicating that electrical power has been lost or monitor a regulated discharge voltage 214 from the each string of batteries 202 to determine whether input electrical power to the system load 212 has been lost.

The MCU 210 also may work in conjunction with a series of switches, including linear regulators (LR1-LR3) 216 and OR-ings (OR1-OR3) 218, associated with each battery string 202 and each BMS 208. In operation, the MCU 210 may drive the switches 216/218 by turning each switch 216/218, independently of each other, to an ON position to allow each battery string 202 to support and to provide electrical power to the system load 212, if needed. Additionally, the MCU 210 may turn each individual switch 216/218 to an OFF position in the event that any battery string 202 is subjected to over-heating, over-voltage, or over-current in an effort to protect the system load 212. For example, the each switch 216/218 may function in the OFF position when abnormal conditions occur, when a given battery string 202 is not needed, or when a battery string 202 voltage is higher than the maximum allowable regulated voltage so that no power can flow from the individual switches 216/218. Conversely, when the voltage of a battery string 202 is within the maximum allowable regulated voltage, each switch 216/218 may individually function in an ON position so that electrical power can flow into the system load 212 by providing a closed circuit.

The combination of the back-to-back switches 216 and 218 may allow each individual battery string 202 to be completely disconnected from the system load 212 when both switches 216/218 are turned OFF. In particular, if any one battery string 202 fails due to being open or short, that BMS 208 of that particular battery string 202 would turn OFF its own switch to disconnect itself from the system load 212. The remaining battery strings 202 may continue to support the reduced system load 212 in an ON position.

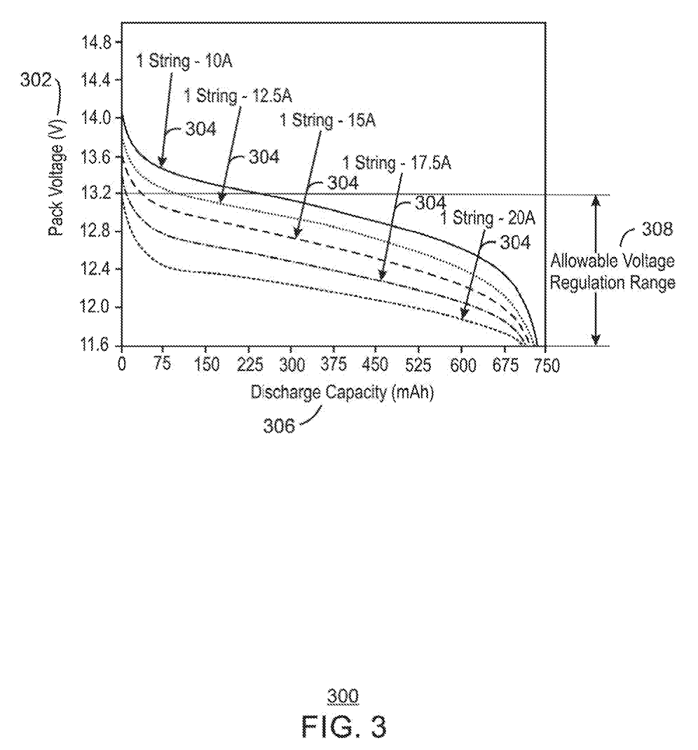

FIG. 3 is a graph 300 of battery voltage and current curves for one (1) battery string. As shown in FIG. 3, the one battery string may provide a battery string voltage 302 that may follow a certain voltage curve 304 depending on its discharge capacity (i.e. output current) 306.

FIG. 3 may assume one battery string including four battery cells in series where a system load may require a regulated discharge voltage between 11.4V and 13.2V. However, the discharge voltage from the battery string may range from 11.6V to 14V at a load current ranging from 10 A to 20 A, as depicted in FIG. 3. As shown in FIG. 3, the voltage curve 304 may be lowest at a load current of 20 A and highest at a lower current of 10 A. Thus, the voltage above the regulation range of 13.2V at lighter loads may be absorbed by one of the aforementioned switches (LR1-LR3; OR1-OR3). Accordingly, the voltage for the battery string may be regulated within the allowable voltage regulation range 308 if the load is 0 A to 20 A for one battery string.

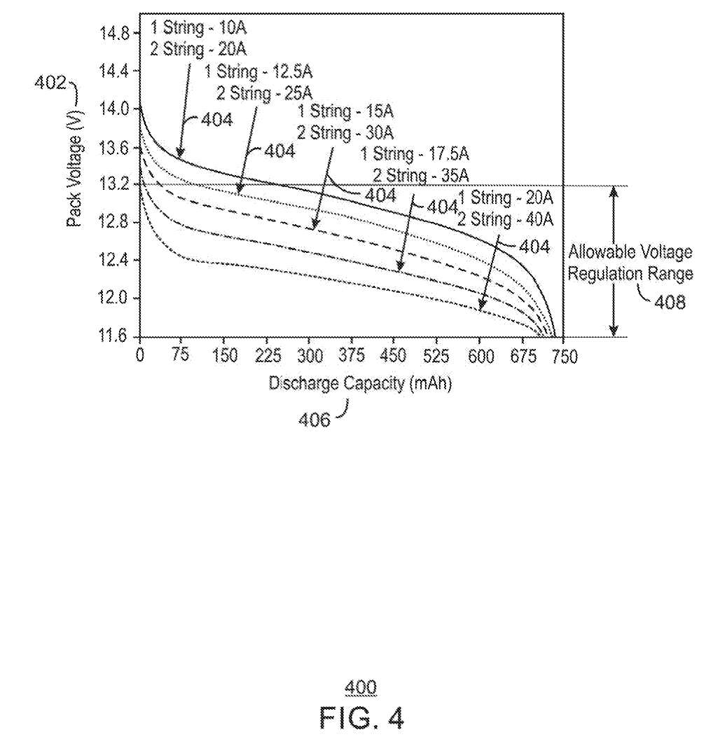

FIG. 4 is a graph 400 of battery voltage and current curves for two (2) battery strings. For a higher current range, e.g., 0 A-40 A, the current range may be divided into two ranges including a 0 A-20 A range and a 20 A-40 A range. As shown in FIG. 4, two battery strings may provide a battery string voltage 402 that may follow a certain voltage curve 404 depending on its discharge capacity (i.e. output current) 406 depending on the two current ranges. If the system load is within the 0 A-20 A range, then only one battery string may be utilized to support a system load. However, if the load is with the 20 A-40 A range, two battery strings may be used to support the higher current range. In the higher current range 20 A-40 A, each battery string may support the 0 A-20 A range. Additionally, the voltage for the combined strings, i.e. 20 A-40 A, may be the same voltage as one battery string, i.e. 0 A-20 A. Thus, the combined voltage of the two battery strings may be able to maintain and regulate an allowable voltage regulation range 408 for the system load with a current range of 0 A-20 A using one battery string and a current range of 20 A-40 A using two battery strings.

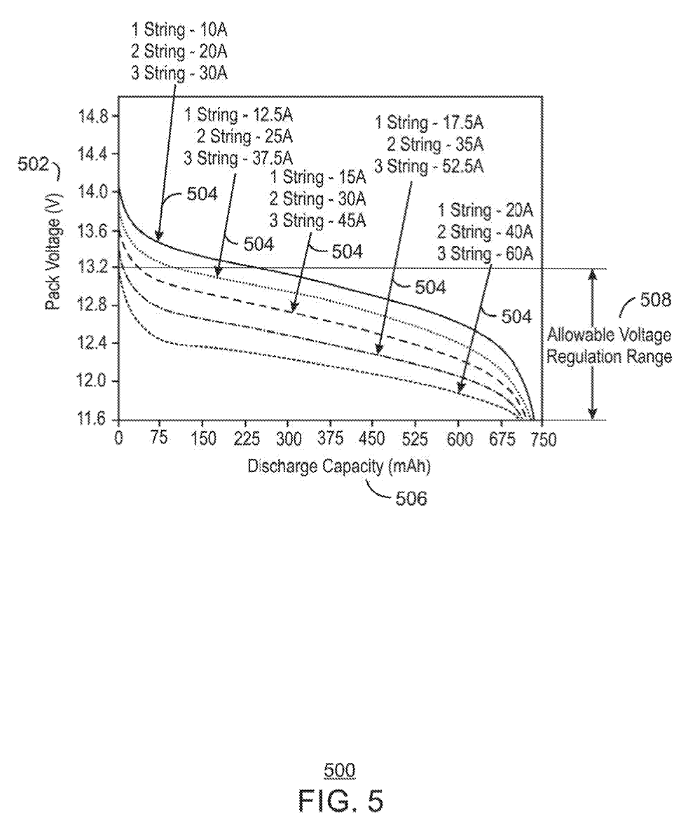

FIG. 5 is a graph 500 of battery voltage and current curves for three (3) battery strings. The voltage range for a system load may include a 0 A-60 A range. As shown in FIG. 5, one battery string may be utilized when the system load is 0 A-20 A, two battery strings may be utilized when the system load is 20 A-40 A, and three battery strings may be utilized when the system load is 40 A-60 A. Each battery string may provide a battery string voltage 502 that may follow a certain voltage curve 504 depending on its discharge capacity (i.e. output current) 506 depending on the current range. If the system load is within the 0 A-20 A range, then only one battery string may be utilized to support a system load. If the system load is within the 20 A-40 A range, two battery strings may be used to support the higher current range. However, if the system load is within the 40 A-60 A range, three battery strings may be used to support the higher current range. Thus, the combined voltage of the three battery strings may be able to maintain and regulate an allowable voltage regulation range 508 for the system load with a current range of 0 A-20 A using one battery string, a current range of 20 A-40 A using two battery strings, and a current range of 40 A-60 A using three battery strings.

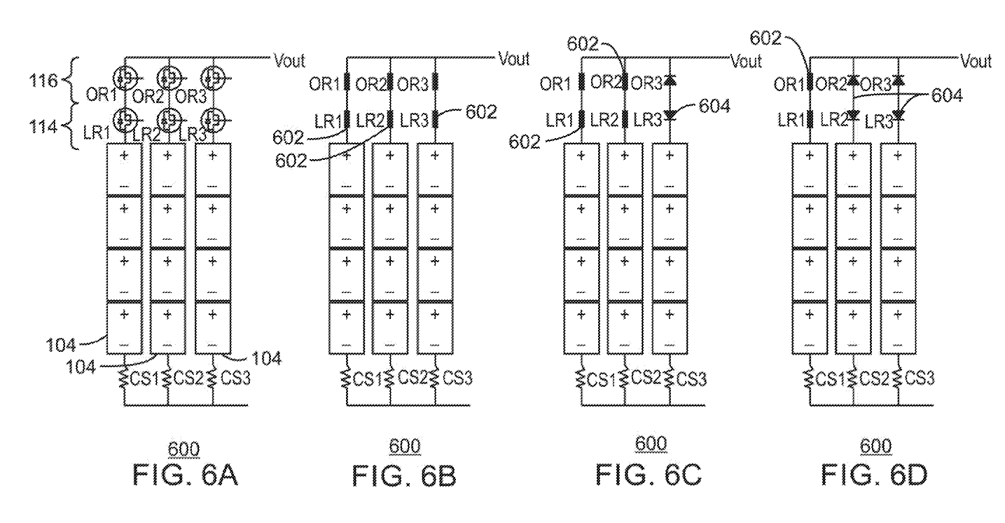

FIGS. 6A-6D provide an illustration of discharging procedures 600 for a battery string. Like numbers are as described with respect to FIG. 1. As shown in FIG. 6A, in normal operating conditions where AC power is being supplied to a system load, all switches 114/116, including LR1-LR3 and OR1-OR3, connected to a string of batteries 104 may be in an open circuit state (i.e. in an OFF position). When in the OFF position, no electrical power may flow through the switches 114/116 as a discharge voltage into the load system (not shown). In operation, all battery strings 104 may be in a stand-by mode and ready for use in the event of an AC power failure. Depending on its charge status, the battery strings 104 may or may not be charged by a charger (not shown) during the stand-by period.

FIG. 6B depicts the utilization of the battery strings 104 to power the load system (not shown) in the event that the AC input power fails. As shown in FIG. 6B, all switches 114/116 may be automatically turned to an ON position 602. All battery strings 104 may be utilized to discharge electrical power to support the system load (not shown). As previously stated, a BMS (not shown) may report the individual discharge currents of each battery string 104 to a MCU (not shown). In operation, the MCU may add each current from each battery string 104 to determine a total system load current. For example, each string 104 may be assumed to be capable of supporting up to 20 A load current. If the total server load current is greater than 40 A, no further action may be required and all switches 114/116 may remain in an ON position 602 to provide electrical power to the system load. In other words, all battery strings 104 may support the current of the system load while maintaining the discharge voltage of the battery within an allowable voltage regulation range.

As shown in FIG. 6C, for a total server load current between 20 A and 40 A, all of the battery strings 104 may not be needed to supply power to the system load (not shown). Thus, one of the battery strings 104 may be turned to an OFF position 604 by an MCU (not shown). Therefore, the remaining two battery strings 104 that are in an ON position 602 may provide sufficient power and may provide a discharge voltage within the allowable voltage regulation range as required by the input converters of the system load.

As shown in FIG. 6D, for a total server load current that is less than 20 A, only one battery string 104 may be sufficient to support the current system load (not shown). Thus, a MCU (not shown) may switch two of the three battery strings 104 into an OFF state 604. The remaining battery string 104 may provide sufficient power and may provide a discharge voltage in an ON position 602 and within an allowable voltage regulation range as required by the input converters of the system load.

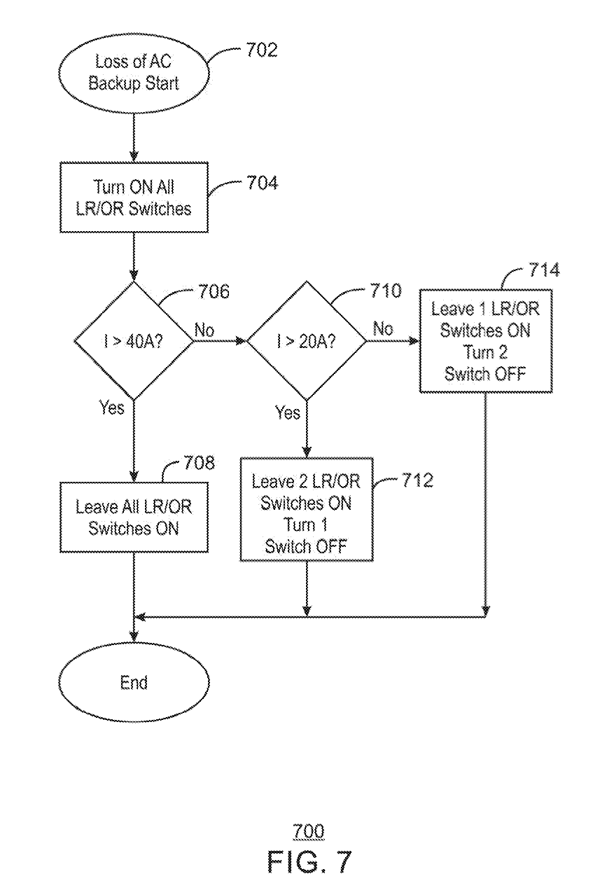

FIG. 7 is a block diagram of a discharging procedure 700 for a battery string. An AC input power source may supply electrical power to an electrical system load. At step 702, the AC power source may fail to provide the requisite power. In such an event, at Step 704, the electrical load system may automatically switch over to a battery power source as its electrical power supplier, where switches connected to the battery may be turned to an ON position to provide an open circuit through which power may flow. The switches may be a combination of linear regulator and OR-ing switches.

In many devices that may use a battery as a power source, more than one battery string may be used at a time. Thus, the battery power source may include a string of batteries that may be grouped together in a serial arrangement to increase the voltage or in a parallel arrangement to increase current.

The battery of strings as discussed with respect to FIG. 1 may include 3 battery strings, where each string may be assumed to be capable of supporting up to a 20 A load. Each battery string may operate independently of each other so that each string may be in an ON position to discharge power or in an OFF position depending on the needs of the system load. Thus, if all 3 battery strings are in an ON position, the battery cell may support up to a 60 A load. At Step 706, it may be determined if the load current of the load system is greater than 40 A. If the load current is greater than 40 A, at Step 708, all three switches may be turned to the ON position, where each switch may support an individual battery string that supplies up to 20 A of load current. At Step 710, if the load current is not greater than 40 A, the method may proceed to determine if the load current is greater than 20 A. At Step 712, if the load current is greater than 20 A so that the load current value is between 20 A and 40 A, the switches associated with two of the battery strings may be turned to an ON position while the switch of the remaining battery string may be turned to an OFF position. At Step 714, if the load current is less than 20 A, only one battery string with associated switches may be turned in the ON position. The other two battery strings with associated switches may be turned in an OFF position so as not to provide electrical power to the load system.

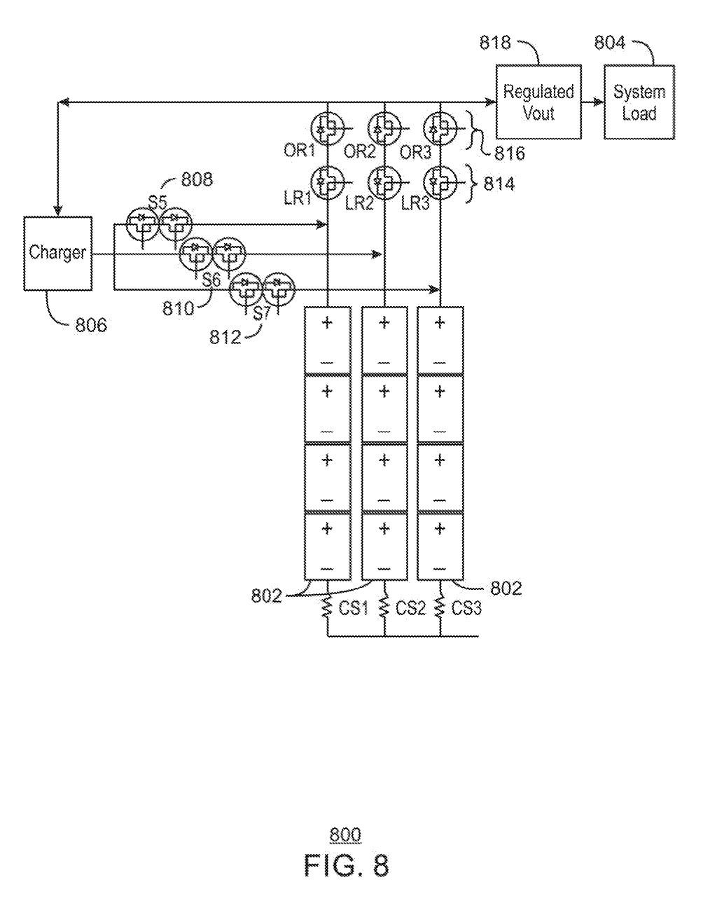

FIG. 8 is an illustration of a charging procedure 800 for each individual battery string. As show in FIG. 8, four batteries are connected in series to provide 3 battery strings 802 connected in a parallel connection. As previously stated each battery string 802 may operate independently of each other so that each battery string 802 may be charged separately and sequentially. The charge status of a battery string 802 may change after it has discharged electrical power to a system load 804. In one or more examples, a BMS (not shown) may detect and report the charge status of the battery string 802 to a MCU (not shown), which may determine which battery string 802 needs to be recharged. As shown in FIG. 8, the charger 806 may charge each battery string 802 based on its charge status.

If a first battery string 802 needs to be charged, switch S5 808 may be turned to an ON position to provide input voltage to the first battery string 802. Switches S6 810 and S7 812 may be turned to an OFF position so as not to receive input voltage and thus, second and third battery strings 802 may not be charged. If the second battery string 802 needs to be charged, its associated switch, S6 810, may be turned to an ON position so that the second battery string 802 may receive input voltage from the charger 806. Accordingly, switches S5 808 and S7 812 will be turned to an OFF position. Similarly, when a third battery string 802 needs to be charged, its associated switch, S7 812, may be turned to an ON position while switches S5 808 and S6 810 are turned to an OFF position. During a charging cycle for each battery string 802, associated LR and OR switches 814/816, may be in an OFF position. In one or more examples, a portion of the discharge voltage exiting the switches 814/816 may be directed to the charger 806 as a source of power.

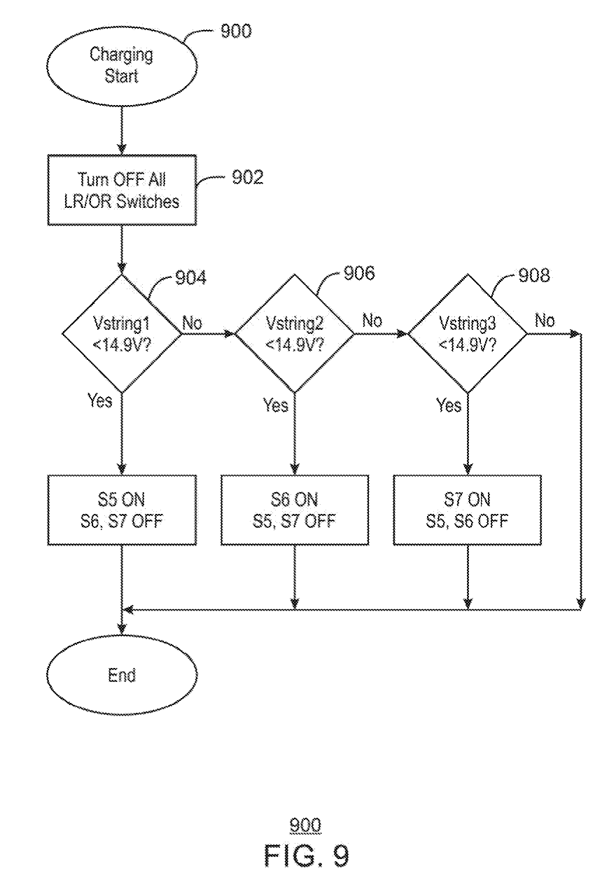

FIG. 9 is a block diagram of a charging procedure 900 for a battery string. After a string of batteries has provided discharged voltage as a power source, each battery string may need to be recharged to its original charging capacity. In one or more examples, a microcontroller (MCU) may be utilized to determine the actual charge status of for each battery string.

At Step 900, the charging of the battery string may begin via the use of a charger. At Step 902, each LR/OR switch associated with a respective battery string may be turned to an OFF position so that electrical power from the charger cannot enter into the switches. At Step 904, the status of a first battery string may be monitored to determine if the battery voltage is less than 14.9V. In one or more examples, the maximum range for a battery string may be 10V to 16.8V.

At step 904 if the battery voltage is less than the maximum voltage of 14.9V, switch S5 that is associated with the first battery switch, may be turned to an ON position so that the first battery string may receive electrical power from the charger. At Step 904, if it is determined that the first battery string does not need to be charged, at Step 906, the charger may then determine if the second battery string needs to be charged. If the battery voltage of the second battery string is less than the maximum voltage of 14.9V, switch S6 may be turned to an ON position. Switches S5 and S7 that are associated with the first battery string and a third battery string may be turned to an OFF position so as to not receive any electrical power from the charger. Similarly, at Step 908, the charge status of the third battery string may be evaluated to determine if the charge is less than the maximum voltage of 14.9V. Likewise, if the battery voltage of the third battery string is less than the maximum voltage of 14.9V, switch S7 may be turned to an ON position. Switches S5 and S6 that are associated with the first battery string and a second battery string may be turned to an OFF position so as to not receive any electrical power from the charger.

The block flow diagrams of FIGS. 7 and 9 are not intended to indicate that each of the block flow diagrams, 700 and 900, are to include all of the components shown in FIG. 7 and FIG. 9. Further, the block flow diagrams 700 and 900 may include fewer or more blocks that what is depicted, and blocks from the block flow diagram 700 may be included in the block flow diagram 900, and vice versa, depending on the details of the specific implementation.

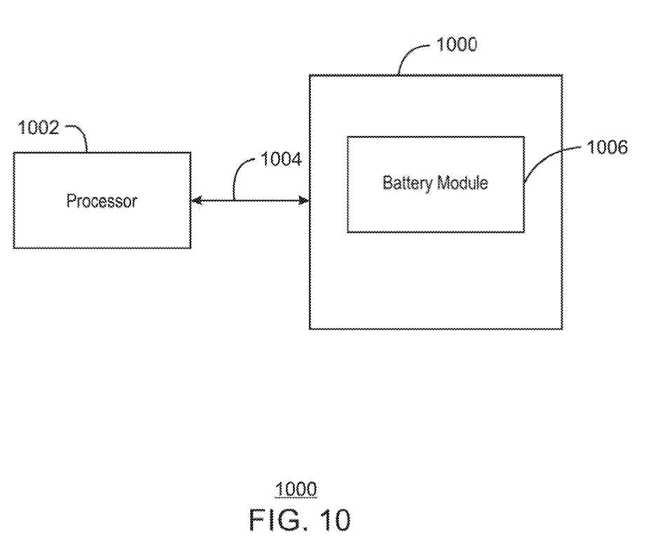

FIG. 10 is a block diagram of a tangible, non-transitory computer-readable medium configured to regulate voltage and current capability for a battery. The tangible, non-transitory computer-readable medium 1000 may be accessed by a processor 1002 over a computer bus 1004. Furthermore, the tangible, non-transitory, computer-readable medium 1000 may include computer-executable instructions to direct the processor 1002 to perform the steps of the current method.

The various software components discussed herein may be stored on the tangible, non-transitory, computer-readable medium 1000, as indicated in FIG. 10.

For example, a battery module 1006 may be configured to power a system load using a plurality of battery strings in parallel, wherein each battery string acts independently of another battery string. The battery module 1006 may be configured to discharge current by turning on a switch for a particular battery string to power the system load. The battery module 1006 may also be configured to determine an individual discharging current through each battery string using a current sensor.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A system for regulating voltage and current capability for a battery, comprising:
at least two parallel battery strings to power a system load, wherein each battery string acts independently of another battery string;
a current sensor to determine an individual discharging current through each battery string in a circuit; and
a switch to power on a particular battery string to support the system load by discharging current.

2. The system of claim 1, wherein a number of battery strings powered on depends, at least in part, on an amount of discharging current needed to support the system load.

3. The system of claim 1, wherein each battery string has its own associated switch to power on the particular battery string.

4. The system of claim 1, further comprising a battery monitoring system (BMS), wherein the BMS can monitor and report the status of each battery string.

5. The system of claim 1, further comprising a microcontroller (MCU), wherein the MCU determines a total of the system load and regulates a status of each switch based on the system load.

6. The system of claim 1, wherein the switch comprises a linear regulator and an OR-ing regulator.

7. The system of claim 1, wherein each battery string is capable of supporting a current range.

8. The system of claim 1, wherein a switch associated with a charger is powered on to individually and sequentially charge an associated battery string.

9. A method for regulating voltage and current capability for a battery, comprising:
providing a plurality of battery strings in parallel to power a system load, wherein each battery string acts independently of another battery string;
turning on a switch to discharge current from a particular battery string to power the system load; and
determining an individual discharging current through each battery string using a current sensor.

10. The method of claim 9, further comprising determining a number of battery strings needed to support the system load.

11. The method of claim 9, wherein each battery string has its own associated switch to discharge current to power the system load.

12. The method of claim 9, further comprising providing a current range that each battery string is built to support.

13. The method of claim 9, further comprising turning off the switch to discharge current to power the system load and turning on a charger switch associated with a battery string to individually and sequentially charge the battery string.

14. A non-transitory computer readable medium including instructions for causing a computer to:
power a system load using a plurality of battery strings in parallel, wherein each battery string acts independently of another battery string;
discharge current by turning on a switch for a particular battery string to power the system load; and
determine an individual discharging current through each battery string using a current sensor.

15. The non-transitory computer readable medium of claim 14, the instructions to cause the computer to:
monitor and report a status of each battery string using a battery monitoring system (BMS); and
determine a total system load and regulate a status of the switch associated with each battery string based on the system load using a microcontroller (MCU).
